(19) United States
(12) Patent Application Publication
(10) Pub. No.: US 2014/0152424 A1
(43) Pub. Date: Jun. 5, 2014

(54) METHOD AND SYSTEM FOR SECURITY SCREENING USING BIOMETRIC VARIABLES

(71) Applicant: UNISYS CORPORATION, Blue Bell, PA (US)

(72) Inventors: Guarrieri Steven, Malvern, PA (US); Brock Scott, Lake Forest, CA (US)

(73) Assignee: Unisys Corporation, Blue Bell, PA (US)

(21) Appl. No.: 13/705,210

(22) Filed: Dec. 5, 2012

(51) Int. Cl. G05B 1/00

(52) U.S. Cl. CPC G05B 1/00
USPC 340/5.82

(57) ABSTRACT

A method and system for security screening a screening subject. The method includes measuring by at least one biometric sensor at least one biometric parameter of the screening subject. The method also includes scoring by a biometric analysis engine coupled to the biometric sensor the at least one biometric parameter measured of the screening subject. The method also includes generating by the biometric analysis engine biometric parameter feedback in such a way that a security screening agent either terminates or escalates the security screening of the screening subject based on the generated biometric parameter feedback.

### BACKGROUND

1. Field

The instant disclosure relates generally to security screening methods and systems, and more particularly, to security screening methods and systems using biometric variables.

2. Description of the Related Art

The need for maintaining security at transportation terminals, public and private buildings, schools and other installations with a relatively high density or high volume of human traffic continues to grow. Authorities tasked with providing and maintaining such security are under pressure to provide suitable security screening while trying to reduce the impact of such security screening on the privacy and mobility of the people being screened. In an attempt to achieve this end, some authorities have chosen to focus security efforts and resources only upon a targeted group of individuals who fit a predetermined “profile.” The practical limitations and legal impediments to profiling are well known, and profiling often cannot be implemented in the vast majority of venues requiring a reliable and legally-defensible security system.

Another security screening method that has been adopted recently by some security services is the detection of momentary or involuntary facial movements known as “micro-expressions.” The theory behind such security methods is that the stress of attempting to conceal illegal behavior or items is manifested by transient, involuntarily facial movements (i.e., micro-expressions). To recognize such expressions, a screening agent individual typically has to undergo relatively extensive training and maintain an almost constant vigilance in observing the faces of the individuals being screened. There remain questions as to the effectiveness of this methodology, such as whether or not there is a correlation between micro-expressions and potentially illegal behavior, and whether or not a security screening agent can maintain the proper level of vigilance in the sometimes chaotic screening environment, such as in an airport or similar travel hub.

Yet another approach of focusing security resources on individuals of interest is the use of multiple sets of questions designed to “flag” certain behaviors or characteristics determined to be “of interest” to a given authority in a given venue. For example, if an individual's answers to a first set of questions are deemed to be innocuous, then that individual could be permitted to pass through a given security checkpoint. However, if one or more answers do not comport with established guidelines, or if the individual being questioned is judged by the questioning agent to be nervous or uncomfortable while answering the questions, then the individual may be subjected to a secondary level of questioning and/or other enhanced security methods. This security approach typically is limited by the skill and objectivity of the screener.

All of these security methodologies often are limited in their effectiveness and consistency by the training, skill and objectivity of the screening agents performing the screening. In a public venue, such as an airport or sporting event, there are numerous challenges hindering agent performance, such as the sheer volume of individuals requiring screening, the repetitive nature of the security procedures, the fact that no two screening agents are likely to interpret an observed response or mannerism or event in exactly the same fashion. There is a need for a system and method to augment and aid security screening agents to lessen or eliminate the effect of these hindrances.

### SUMMARY

Disclosed is a method and system for security screening a screening subject. The method includes one or more biometric sensors measuring one or more biometric parameters of the screening subject. The method also includes a biometric analysis engine coupled to the biometric sensors scoring the biometric parameters measured of the screening subject. The method also includes the biometric analysis engine generating biometric parameter feedback in such a way that a security screening agent either terminates or escalates the security screening of the screening subject based on the generated biometric parameter feedback.

### BRIEF DESCRIPTION OF THE DRAWINGS

FIG. 1 is a schematic view of a system for security screening using biometric variables, according to an embodiment;

FIG. 2 is a flow diagram of a method for security screening using biometric variables, according to an embodiment;

FIG. 3 is a graphical representation of biometric data collected as part of a system and method for security screening using biometric variables, according to an embodiment;

FIG. 4 is another graphical representation of biometric data collected as part of a system and method for security screening using biometric variables, according to an embodiment; and

FIG. 5 is a schematic diagram of a portion of a biometric processor/controller analysis engine for a system for security screening using biometric variables, according to an embodiment.

### DETAILED DESCRIPTION

In the following description, like reference numerals indicate like components to enhance the understanding of the disclosed method and apparatus for providing low latency communication/synchronization between parallel processes through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

There are several factors that typically affect the effectiveness of conventional security checkpoint systems, including the security agents conducting the screening (and their associated training), various forms of video technology that record and monitor people and their belongings, and the security procedures or processes, which govern both the use and effectiveness of human resources and the associated technology being used. The burden at security checkpoints, such as a customs counter in the transportation industry, often falls on “behavioral detection” officers. Our governments are spending millions of dollars for training for such personnel, and typically observation techniques alone are not proving successful. When training dollars are even more difficult to apply, such as an education center or a “staged” event (e.g., concerts or sporting events), the security solution often involves a technology “mash-up” to significantly increase effectiveness.

One of the purposes of a security screening system is to filter a general population under evaluation to identify persons for which additional analysis may be appropriate. Security screening typically is an escalation process, where threshold indicia are defined for which a follow-up or a “second look” action may be deemed appropriate.

To improve conventional security checkpoint systems, more objective techniques can be applied in combination with a series of question and answer (Q&A) “gates” to more effectively and more expeditiously move security screening subjects through the security screening process. An improved security screening system and security screening approach can include biometric measurements that reduce the subjectivity and the error-prone nature of human evaluators, and thereby improve the overall effectiveness of the security screening process. Sensors considered for biometric parameter collection can be any type of sensor that performs a relatively non-invasive collection of data in a normal security system environment. Such an improved security screening system can use remote, passive sensors (i.e., no physical contact with the screening subjects). The use of such sensors distinguishes the security screening system from conventional security screening systems that use more invasive detection systems, such as lie detectors and other similar security screening equipment. Also, the use of remote, passive sensors reduces or eliminates possible profiling biases, which is one of several disadvantages of conventional “human resource” security screening systems.

Some of the elements of an improved security screening method are the use of objective biometric measurements and their rate of change over a relatively short time interval, e.g., in response to some “stimulus.” In this manner, multiple biometric parameters can be used in combination to provide a basis for analysis and evaluation.

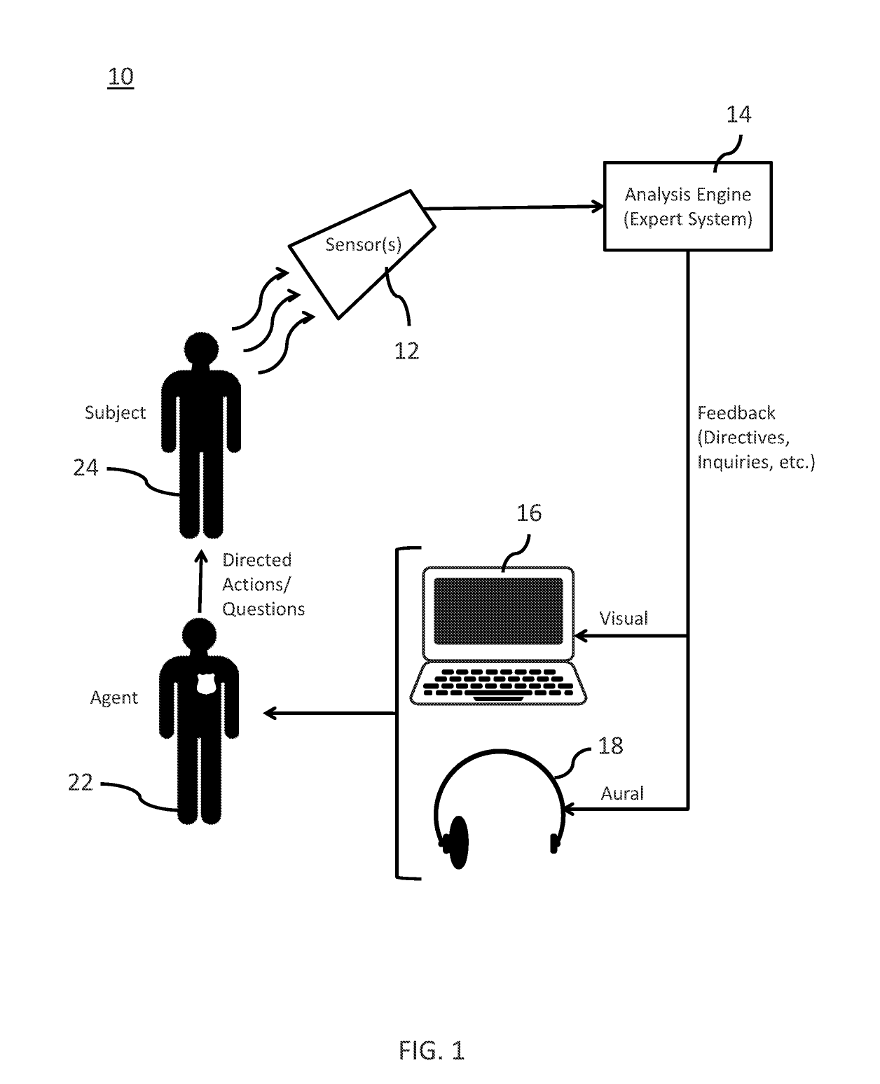

FIG. 1 is a schematic view of a system 10 for security screening using biometric variables, according to an embodiment. The system 10 includes one or more biometric sensors 12, a biometric processor/controller analysis engine 14, and visual and/or aural feedback components, such as a display screen or computer 16, a microphone and/or headphones 18 and/or other suitable components that can provide appropriate feedback to one or more security screening agents 22 who are screening one or more security screening subjects 24.

In the system 10, a plurality of biometric sensors that measure or capture biometric parameters and their rate of change over a given time interval are combined to provide a set of multi-dimensional biometric variables as inputs to a programmatic (automated) decision threshold. The biometric parameters measured/captured by the biometric sensors can include a screening subject's heart/pulse rate, eye movement, facial temperature and voice pitch variation. This biometric criteria can determine when it is appropriate to escalate additional questioning, thereby producing a second set of biometric feedback and heightened scrutiny.

Because biometric sensors produce relatively accurate, repeatable, and objective measurements of non-volitional criteria, human biases are reduced if not eliminated in this determination. The non-invasive nature of biometric sensors in combination with other suitable technology allows for relatively rapid data capture, assessment and feedback, therefore increasing the rate of screening of the security screening system without drawing undue attention to potential security threats. Gathering the biometric information from the screening subjects is performed in a non-intrusive manner to avoid security screening subject objections that otherwise might be based on the real or perceived offensive manner of a security screening system that makes use of intrusive data collection. Escalation is determined by a new set of processes that draw on biometric feedback.

The system 10 evaluates screening subjects (e.g., travelers) at consistent “choke points” in the screening process where subject traffic provides a consistent environment (minimal variability) and a setting where measurements and interactions are most similar. For example, choke points can include a check-in station to a security queue where identification and travel pass must be shown, stations where there is a screening subject queue for metal detectors (or where screening subjects are “wanded” manually), and a customs checkpoint. At these choke points, screening subjects usually interact with screening agents in some form, e.g., verbally or by showing documents. At these choke points, screening subjects usually spend a short but sufficient time in a fixed place where biometric information can be obtained in a non-intrusive manner.

During the biometric measurement process, one or more biometric sensors can take one or more baseline or initial measurements prior to any interaction with the screening infrastructure staff. Shortly thereafter, similar biometric measurements are repeated, typically after some interaction (stimulus), to determine the rate of change of each biometric parameter. The biometric processor/controller analysis engine 14 includes an objective decision algorithm, based on weighted baseline and rate of change measurements, that is used to score or rate the interaction. For outlying scores, a determination threshold is set for the determination of the relative value of a binary decision to escalate the interaction, e.g., more focused interactions or questioning of the screening subject. Also, the system 10 is useful for considerations outside of the security context. For example, the system 10 can identify screening subjects under severe medical stress or extreme agitation, for which an appropriate interaction may be desired as a public safety consideration.

The biometric measurements that are useful in this type of evaluation, and for which data can be gathered in a non-intrusive manner under initial consideration, can include heart/pulse rate, eye movement, facial temperature and voice pitch variation. The heart/pulse rate biometric measurement is a non-voluntary autonomic response. The heart/pulse rate is one of the biometric parameters used in lie detectors as indicia of deception. A general population has a predictable distribution. Elevated baseline measurements, well out of the norm, are indicia of stress or agitation. In particular, dramatic rates of change of heart/pulse rate associated with specific stimulus (e.g., keywords used in questions), can be indicative of stress and/or agitation in the screening subject. As part of the system 10, a screening subject's heart/pulse rate can be non-intrusively obtained in real time by a closely proximate sensor, e.g., a sensor mat when a screening subject is in stocking feet. Alternatively, a screening subject's heart/pulse rate can be non-intrusively obtained in real time by one or more low frequency (e.g., 200 Hz filtered) audio detectors.

Another biometric measurement is eye movement. Facial recognition and image analysis software from a security camera can track what a screening subject is focused on. The relative lack of eye contact with the interviewer or an out of the norm focus on some object (e.g., poster in the security screening area) could be useful in determining stress or agitation on the part of the screening subject. As part of the system 10, the use of properly positioned ubiquitous security cameras can gather appropriate eye movement information non-intrusively in real time.

Another biometric measurement is facial temperature distribution. A thermal security camera can be used to gather such useful information from a screening subject. For example, a thermal picture of the tear duct of a screening subject can provide a relatively accurate determination of the core body temperature of a screening subject. A facial flushing non-volitional reaction related to anger or embarrassment (e.g., in response to a question) can be determined or obtained by monitoring the temperature differential between the cheek temperature and the eye duct temperature of the screening subject. As part of the system 10, one or more properly positioned ubiquitous security cameras can be used to gather this information from a screening subject in a non-intrusive manner in real time.

Another biometric measurement is voice pitch variation. Some research suggests that when a person is trying to deceive another person in verbal exchanges, the deceptive subject tends to atypically minimize voice pitch and volume levels in the verbal exchange compared to a typical verbal exchange. Some research identifies other aspects of voice stress indicia. Because voice pitch data can be gathered in real time from a screening subject using a microphone, voice pitch data can be obtained in a non-intrusive manner in real time.

As other biometric parameters are identified and biometric sensor technology evolves, the system 10 can employ additional biometric sensors 12 to increase the accuracy of the biometric data collected and the overall effectiveness of the screening activity of the system 10. Also, as part of the screening process of the system 10, question and answer guidance can be provided to the screening agents, along with a scoring or evaluation table, which works to direct the screening process and remove error-prone subjectivity on the part of the screening agents. A clear and concise question and answer process augmented with biometric parameter measurements provides for an efficient, repeatable security screening process.

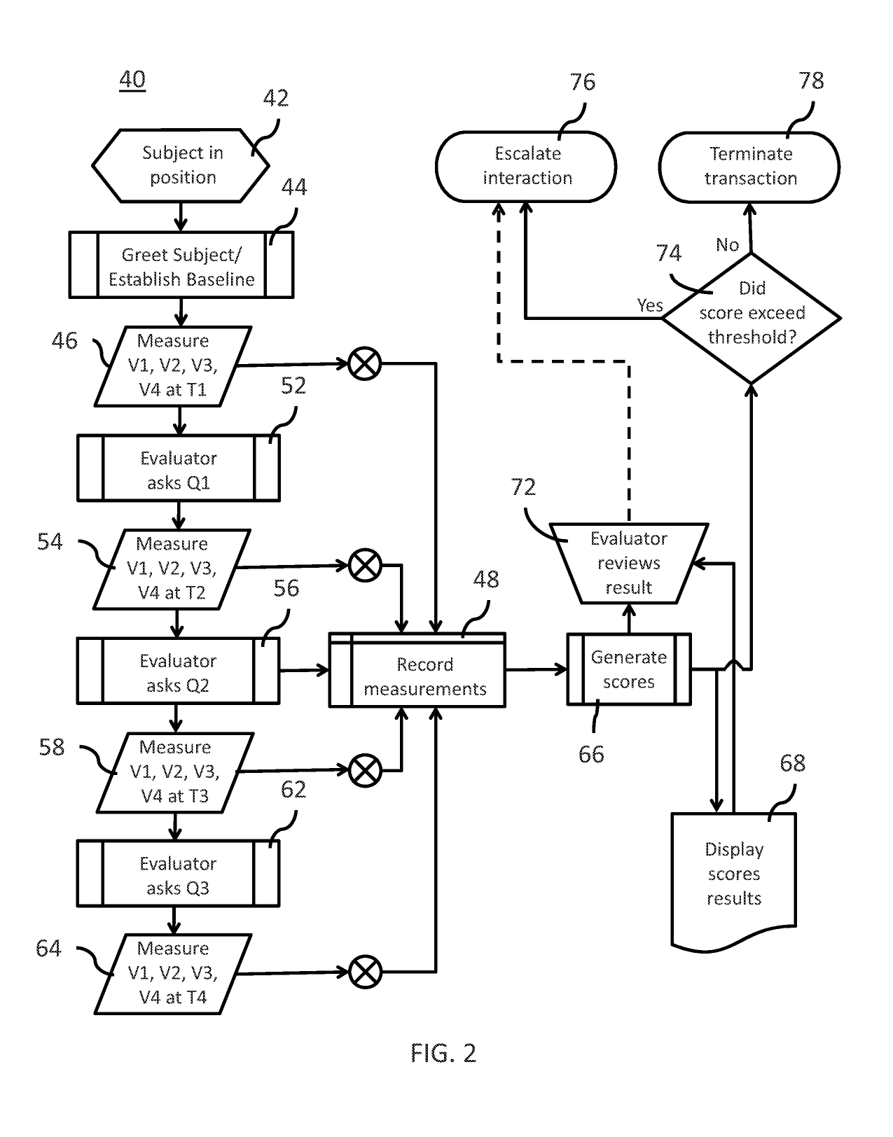

FIG. 2 is a flow diagram of a method 40 for security screening using biometric variables, according to an embodiment. The method 40 includes a step 42 in which a screening subject moves or is moved into screening position. As discussed hereinabove, depending on the biometric sensor or sensors being used as part of the system 10 and method 40, the screening subject moves or is urged to move onto a sensor mat, or into position for one or more security cameras and/or security microphones to monitor the screening subject during the screening process. The method 40 also includes a step 44 of one or more security agents or evaluators greeting the screening subject, e.g., to make sure the screening subject is appropriately positioned for one or more biometric sensors to properly perform biometric measurements on the screening subject.

The system 10, including the biometric processor/controller analysis engine 14, includes a scoring algorithm and/or suitable evaluation module or process that provides data used as a basis for evaluation of the screening subjects. The evaluation process receives as input one or more biometric measurements taken from a screening subject, e.g., at two or more points in time, so that the rate of change of biometric parameter(s) can be determined. For example, in the method 40, there can be four non-invasive biometric parameters (V₁, V₂, V₃ and V₄), and each biometric parameter can be measured and recorded at four different points in time (T₁, T₂, T₃ and T₄).

With respect to biometric parameter measurements, the method 40 involves at least one biometric parameter (V₁) being measured for a screening subject during at least two points in time (T₁), (T₂). Such case would generate two measurements V₁(T₁), V₁(T₂) and a rate of change V₁(T₁)−V₁(T₂). Typically, the method 40 involves multiple biometric parameter being measured (Vₙ with n>1) at multiple points in time (Tₘ with m>1). For example, as discussed hereinabove, the method 40 can involve four biometric parameters being measures at four points in time. With respect to notation, a biometric value at a point in time will be labeled herein as Vₙ(Tₘ), with n, m=1 to 4, and is represented by a single valued scalar number.

The method 40 includes a step 46 of measuring one or more biometric parameters (V₁, V₂, V₃ and V₄) of a screening subject at a first point in time (T₁). This initial measurement of one or more biometric parameters can be considered as providing a baseline reading or representation of the biometric parameters for the screening subject. Therefore, the initial measurement step 46 typically is performed before a screening agent asks the screening subject any questions or otherwise provides the screening subject with any type of stimulus to which the screening subject may respond.

The method 40 also includes a step 48 of recording the biometric parameter measurements (Vₙ, T₁). The measurements can be recorded in any suitable manner, e.g., on a memory element contained within or coupled to the biometric processor/controller analysis engine 14.

The method 40 also includes a step 52 of the screening agent or evaluator asking the screening subject a first question (Q₁), which can be considered a first screening stimulus, to which the screening subject may respond. The question asked of the screening subject by the screening agent can be any suitable question that elicits a response by the screening subject for a first set of biometric parameters to be measured or captured.

The method 40 also includes a step 54 of measuring one or more biometric parameters (V₁, V₂, V₃ and V₄) of the screening subject at a second point in time (T₂). This second set of measurements of one or more biometric parameters can be considered to be in response to the first question or first stimulus asked of or presented to the screening subject. After the biometric parameters are measured at the second point in time, the biometric parameter measurements (Vₙ, T₂) are recorded (step 48).

The method 40 also includes a step 56 of the screening agent or evaluator asking the screening subject a second question (Q₂) to which the screening subject may respond. As with the first question asked of the screening subject by the screening agent, the second question asked of the screening subject by the screening agent can be any suitable question or screening stimulus that causes a response by the screening subject for which biometric parameters can be measured.

The method 40 also includes a step 58 of measuring one or more biometric parameters (V₁, V₂, V₃ and V₄) of the screening subject at a third point in time (T₂), i.e., after the second screening question has been asked of the screening subject. This third set of measurements of one or more biometric parameters can be considered to be in response to the second question or stimulus asked of or presented to the screening subject. After the biometric parameters are measured at the third point in time, the biometric parameter measurements (Vₙ, T₃) are recorded (step 48).

The method 40 also includes a step 62 of the screening agent asking the screening subject a third question (Q₃) to which the screening subject may respond. As with the first and second questions asked of the screening subject by the screening agent, the third question asked of the screening subject by the screening agent can be any suitable question or screening stimulus that causes a response by the screening subject for which biometric parameters can be measured.

The method 40 also includes a step 64 of measuring one or more biometric parameters (V₁, V₂, V₃ and V₄) of the screening subject at a fourth point in time (T₄), i.e., after the third screening question has been asked of the screening subject. This fourth set of measurements of one or more biometric parameters can be considered to be in response to the third question or stimulus asked of or presented to the screening subject. After the biometric parameters are measured at the fourth point in time, the biometric parameter measurements (Vₙ, T₄) are recorded (step 48).

The method 40 also includes a step 66 of generating scores associated with the measured biometric parameters. The score generating step 66 can be performed by the biometric processor/controller analysis engine 14 or other suitable components of the security screening system 10.

The method 40 also includes a step 68 of displaying the generated scores associated with the measured biometric parameters. The score displaying step 68 can be performed by the biometric processor/controller analysis engine 14 or other suitable components of the security screening system 10, such as the display screen or computer 16.

Using the biometric parameter data measured and recorded, the rate of change for a measurement from the baseline time (T₁) and at times T₂, T₃, and T₄ is determined by the difference V₁(T₁)−Vₙ(Tₘ), where in this rate of change calculation n=1 to 4, m=2 to 4. The rate of change is represented by a single valued scalar number.

In the method 40, once the measuring step 64 is completed and the measurements recorded (step 48), there are a number of biometric measurements, e.g., sixteen biometric measurements, which can be identified or represented by 4×4 matrix:

| | | | |
|---|---|---|---|
| V₁(T₁), | V₁(T₂), | V₁(T₃), | V₁(T₄), |
| V₂(T₁), | V₂(T₂), | V₂(T₃), | V₂(T₄), |
| V₃(T₁), | V₃(T₂), | V₃(T₃), | V₃(T₄), |
| V₄(T₁), | V₄(T₂), | V₄(T₃), | V₄(T₄). |

Also there are a number of rate-of-change parameters, e.g., twelve rate-of-change parameters, which can be identified or represented by a 3×4 matrix:

| | | |
|---|---|---|
| V₁(T₁) − V₁(T₂), | V₁(T₁) − V₁(T₃), | V₁(T₁) − V₁(T₄), |
| V₂(T₁) − V₂(T₂), | V₂(T₁) − V₂(T₃), | V₂(T₁) − V₂(T₄), |
| V₃(T₁) − V₃(T₂), | V₂(T₁) − V₃(T₃), | V₃(T₁) − V₃(T₄), |
| V₄(T₁) − V₄(T₂), | V₄(T₁) − V₄(T₃), | V₄(T₁) − V₄(T₄). |

In some implementations, it is possible to use the maximum rate-of-change values for a particular biometric parameter, which can be defined as follows:

V₁[Max]=Largest value from the set V₁(T₁)−V₁(T₂), or V₁(T₁)−V₁(T₃), or V₁(T₁)−V₁(T₄).

V₂[Max]=Largest value from the set V₂(T₁)−V₂(T₂), or V₂(T₁)−V₂(T₃), or V₂(T₁)−V₂(T₄).

V₃[Max]=Largest value from the set V₃(T₁)−V₃(T₂), or V₂(T₁)−V₃(T₃), or V₃(T₁)−V₃(T₄).

V₄[Max]=Largest value from the set V₄(T₁)−V₄(T₂), or V₄(T₁)−V₄(T₃), or V₄(T₁)−V₄(T₄).

Ideally, the value distribution for a general population of a biometric parameter (or parameter rate of change) measurement is either approximately Gaussian or approximately symmetric about a central peak value to enable a determination or selection of a minimum threshold value and/or a maximum threshold value. The threshold values are used to identify when an individual biometric measurement meets a given criteria to identify it as an “outlier.” For example, for an approximately Gaussian distribution of values, setting the threshold at a certain sigma level provides a comparison value to determine if an individual biometric measurement of a given biometric parameter is a relatively rare or relative common general population value. If an individual biometric measurement is outside of the sigma thresholds, the individual biometric measurement typically is considered a significant variation from the norm, and that individual biometric measurement can be flagged. The flagged biometric measurement then can be represented as a binary or Boolean value as an “exception.”

For approximately symmetric distributions, a linear scale (e.g., 0 at the normal peak and 100 at some minimum or maximum cutoff value) can be used so that a threshold value can be set with a value between 0 and 100. The threshold value can be represented by Vₙ[SETPOINT](or Vₙ[dSETPOINT] for a rate-of-change threshold).

Also, in some implementations, a “weighing function” may be used to scale measured biometric parameter values. The various biometric parameter values have differences in both relative significance and distribution profiles, which may deviate greatly from distributions that are approximately symmetric. The weighting function can be used as a “normalizing” factor or function, and can be a single valued scalar value or a two variable polynomial function to provide an approximately Gaussian distribution or other approximately symmetric distribution of parameter values (or a parameter value rate of change).

The weighting function also scales the relative significance of one specific parameter value to another specific parameter value. For example, the decision algorithm might view the biometric parameter V₁ to be four times more important than another biometric parameter, such as V₂. When used, the weighting function is the product of the weighting function and the specific measured biometric parameter value (instead of just the measure biometric parameter value) that is used for the threshold scaling and the threshold set point value. In the V₁-V₂ example, the V₁ scaling function contains a factor of four. The weighting function can be represented by Vₙ[Weight].

The score generating step 66 can include a scoring scheme whose function is to provide a binary decision based on a given decision-making process. For example, the output of the scoring scheme can set the value of a variable “ESCALATE” to either true or false. If the variable ESCALATE is set to true, then additional screening and/or interaction between the screening agent and the screening subject is determined to be appropriate. A few example scoring schemes and their decision-making process are discussed hereinbelow.

One example scoring scheme or process can include counting “exceptions.” An exception can be defined as a countable event when a specific biometric parameter value (P[Count]) or biometric rate-of-change parameter value (dP[COUNT]) exceeds the threshold level Vₙ[SETPOINT]. The threshold level Vₙ[SETPOINT] may be set with to a specific biometric parameter value or may be the product of that value and its weighting function, as discussed hereinabove.

To calculate the biometric parameter value P[Count], start by setting P[COUNT]=0. For a single biometric parameter measurement, for each n and m, if Vₙ^{TM} (i.e., each biometric parameters value (Vₙ) taken at each point in time (T_{M}))>Vₙ[SETPOINT], then P[COUNT]=P[COUNT]+1. To calculate the biometric rate-of-change parameter value (dP[COUNT]), start by setting dP[COUNT]=0. For a biometric rate of change parameter measurement, for each appropriate n and m, if V(T₁)−Vₙ₁ Tₘ>Vₙ[dSETPOINT], then dP[COUNT]=dP[COUNT]+1.

With regard to the ESCALATE variable, the value of the ESCALATE variable can be based on the value of P[COUNT] or dP[COUNT] or the sum of P[COUNT] and dP[COUNT]. For example, ESCALATE=True iff (if and only if) P[COUNT]>1 or, ESCALATE=True iff dP[COUNT]>0 or, ESCALATE=True iff P[COUNT]+dP[COUNT]>2.

Another example scoring scheme or process can be a single numerical value scoring scheme, in which the biometric parameter measurement values and the biometric rate-of-change parameter values are consolidated into a single value ([RESULT]) for which the ESCALATE variable is set to true when the value of the RESULT variable exceeds a threshold value. One example of this single numerical scoring is to calculate the sum of the products at a given point in time, and then sum the product of the value of the individual biometric parameters (V₁, V₂, V₃ and V₄) at time (t) by the weighting function for that biometric parameter. That is, at time=t, RESULT(t)=(V₁(Tₜ)*V₁[Weight])+(V₂(Tₜ)*V₂[Weight])+(V₃(Tₜ)*V₃[Weight])+(V₄(Tₜ)*V₄[Weight]). For time t=2, 3, or 4, the biometric parameter measurement values Vₙ(Tₜ) can be replaced by the biometric rate-of change parameters values Vₙ(T₁)−Vₙ(T₁), and a similar (single numerical value) score is obtained. Also, the ESCALATE variable can be based on the value of RESULT(t) exceeding some predetermined threshold value.

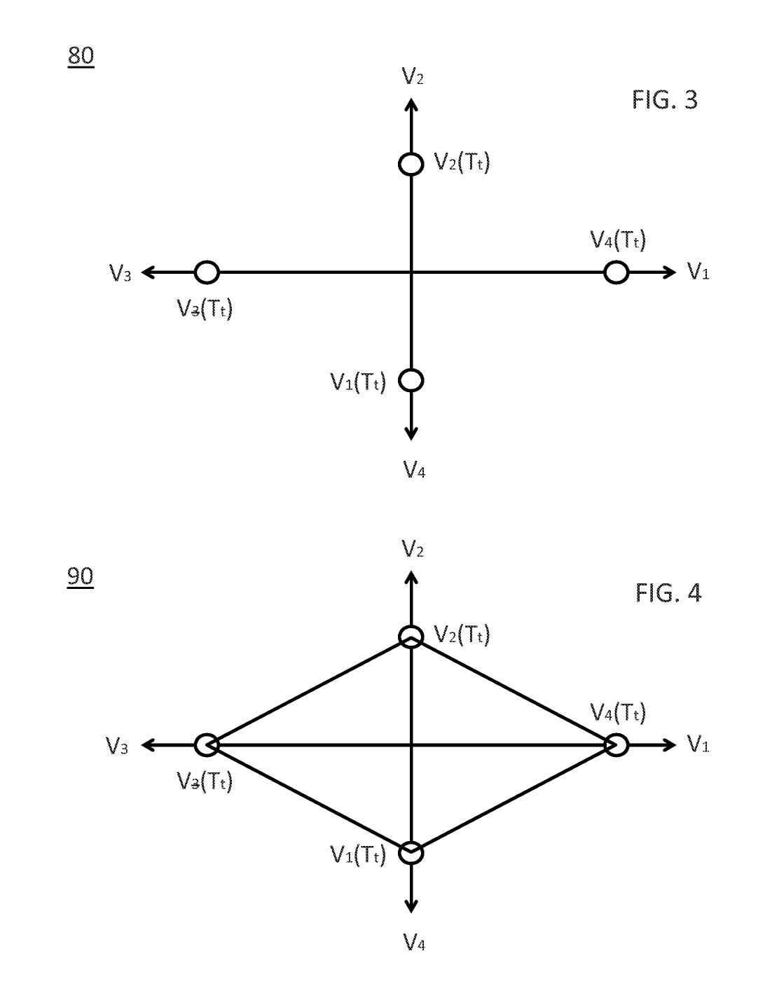

Another example scoring scheme or process can be based on a graphical representation of the measured biometric parameters data for which either an area value may be derived or some specific pattern may be exhibited. For example, in the example discussed hereinabove, four biometric parameters are measured. In the graphical representation scoring scheme, a graph is constructed for which the positive x axis represents V₁, the positive y axis represents V₂, the negative x axis represents V₃, and the negative y axis represents V₄. FIG. 3 is a graphical representation 80 of biometric data collected as part of a system and method for security screening using biometric variables, according to an embodiment. The graphical representation 80 in FIG. 3 illustrates what the graphical representation of this data will look like at time t (t=1,2,3,4).

With this graphical representation 80, a polygon can be constructed by connecting the data points. FIG. 4 is a graphical representation 90 of a polygon formed by connecting biometric parameter data points collected as part of a system and method for security screening using biometric variables, according to an embodiment. The area of this polygon is: ((V₁(Tₜ)*V₂(Tₜ))/2)+((V₂(Tₜ)*−V₃(Tₜ))/2)+((−V₃(Tₜ)*−V₄(Tₜ))/2)+((−V₄(Tₜ)*V₁(Tₜ))/2). The formula is derived from “The Surveyor's Area Formula.”

As in the single value scoring scheme, the graphical representation scoring scheme can generate a single score that can set the ESCALATE variable=true when a predetermined set point is exceeded for one or more points in time. Alternatively, any change in the area of the polygon at two different points in time may be used to set the ESCALATE variable=true when the change in the area of the polygon exceeds a given set point.

Also, one or more pattern recognition processes that are based on geometric equivalence can be used to set the ESCALATE variable=true when the generated pattern matches, to some appropriate degree, predetermined patterns, perhaps based on research, experimentation, or historical evidence that provides confidence that this specific pattern requires escalation.

The method 40 also includes a step 72 of one or more screening agents or other appropriate evaluators reviewing the results of the score generating step 66 and/or the score displaying step 68. As discussed hereinabove, one or more scoring schemes or processes can be used to analyze the measured biometric parameter values associated with a screening subject. Depending on the scoring scheme(s) or process(es) used, the evaluator can immediately asses the results of the measured biometric parameter values associated with a screening subject.

The method 40 also includes a decision step 74 of determining whether or not a scoring scheme score exceeds a threshold level. As discussed hereinabove, one or more scoring schemes or processes can be used to analyze the measured biometric parameter values associated with a screening subject.

If the score as determined by one or more scoring schemes or processes does not exceed a threshold level (No), the method proceeds to a step 76, whereby the interaction between the screening agent or agents and the screening subject is terminated. In this manner, the screening subject would proceed through the security screening process, perhaps with no other security screening measures to undergo.

If the score as determined by one or more scoring schemes or processes exceeds a threshold level (Yes), the method proceeds to a step 78, whereby the interaction between the screening agent or agents and the screening subject is escalated. In this manner, the screening subject would likely undergo further security screening measures by one or more security screening agents. Such further security screening measures may or may not include additional security screening using biometric variables and/or other security screening processes, including conventional security screening processes.

It should be understood that suitable variations to the method 40 can be used. For example, with respect to the step 72 of one or more screening agents or other appropriate evaluators reviewing the results of the score generating step 66 and/or the score displaying step 68, depending on the scoring scheme(s) or process(es) used, the evaluator can immediately decide to escalate the interaction (shown generally as the dashed line between the evaluation step 72 and the escalation step 76). However, it should be understood that any subjectivity exhibited by the evaluator in escalating the interaction clearly is secondary to the objective decision step 74. Other suitable variations to the method 40 can be employed as well, and are understood to be within the scope of the invention.

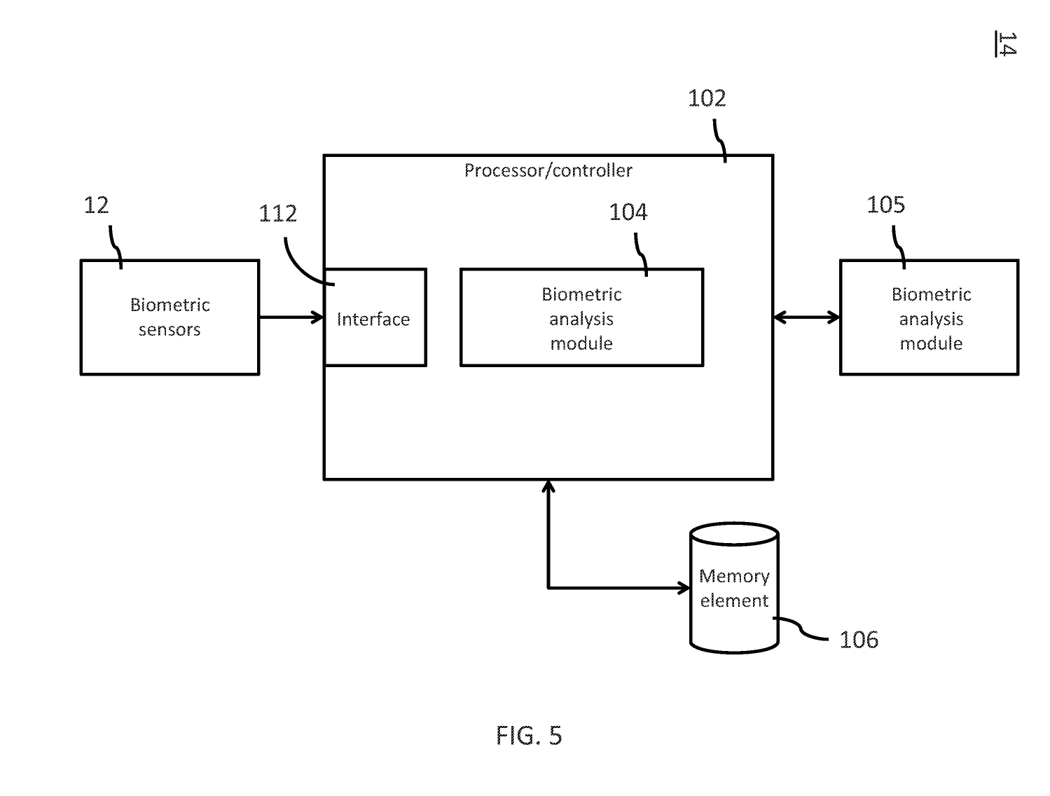

FIG. 5 is a schematic diagram of a portion of the biometric processor/controller analysis engine 14 for the system for security screening using biometric variables, according to an embodiment. The biometric processor/controller analysis engine 14 can be any apparatus, device or computing environment suitable for providing biometric parameters data analysis and decision-making for security screening using biometric variables, according to an embodiment. For example, the biometric processor/controller analysis engine 14 can be or be contained within any suitable computer system, including a mainframe computer and/or a general or special purpose computer.

The biometric processor/controller analysis engine 14 includes one or more general purpose (host) controllers or processors 102 that, in general, processes instructions, data and other information received by the biometric processor/controller analysis engine 14. The processor 102 also manages the movement of various instructional or informational flows between various components within the biometric processor/controller analysis engine 14. The processor 102 can include a biometric analysis module 104 that is configured to execute and perform the biometric analysis and decision making processes described herein. Alternatively, the biometric processor/controller analysis engine 14 can include a standalone biometric analysis module 105 coupled to the processor 102.

The biometric processor/controller analysis engine 14 also can include a memory element or content storage element 106, coupled to the processor 102, for storing instructions, data and other information received and/or created by the biometric processor/controller analysis engine 14. In addition to the memory element 108, the biometric processor/controller analysis engine 14 can include at least one type of memory or memory unit (not shown) within the processor 102 for storing processing instructions and/or information received and/or created by the system 100.

The biometric processor/controller analysis engine 14 also can include one or more interfaces 112 for receiving instructions, imagery, data and other information from one or more of the biometric sensor elements 12. It should be understood that the interface 112 can be a single input/output interface, or the biometric processor/controller analysis engine 14 can include separate input and output interfaces.

One or more of the processor 102, the biometric analysis module 104, the biometric analysis module 105, the memory element 108 and the interface 112 can be comprised partially or completely of any suitable structure or arrangement, e.g., one or more integrated circuits. Also, it should be understood that the biometric processor/controller analysis engine 14 includes other components, hardware and software (not shown) that are used for the operation of other features and functions of the system 100 not specifically described herein.

The biometric processor/controller analysis engine 14 can be partially or completely configured in the form of hardware circuitry and/or other hardware components within a larger device or group of components. Alternatively, the processes performed by the biometric processor/controller analysis engine 14 can be partially or completely configured in the form of software, e.g., as processing instructions and/or one or more sets of logic or computer code. In such configuration, the logic or processing instructions typically are stored in a data storage device, e.g., the memory element 108 or other suitable data storage device (not shown). The data storage device typically is coupled to a processor or controller, e.g., the processor 102. The processor accesses the necessary instructions from the data storage element and executes the instructions or transfers the instructions to the appropriate location within the biometric processor/controller analysis engine 14.

One or more of the biometric analysis module 104 and the biometric analysis module 105 can be implemented in software, hardware, firmware, or any combination thereof. In certain embodiments, the module(s) may be implemented in software or firmware that is stored in a memory and/or associated components and that are executed by the processor 102, or any other processor(s) or suitable instruction execution system. In software or firmware embodiments, the logic may be written in any suitable computer language. One of ordinary skill in the art will appreciate that any process or method descriptions associated with the operation of the biometric analysis module 104 and the biometric analysis module 105 may represent modules, segments, logic or portions of code which include one or more executable instructions for implementing logical functions or steps in the process. It should be further appreciated that any logical functions may be executed out of order from that described, including substantially concurrently or in reverse order, depending on the functionality involved, as would be understood by those reasonably skilled in the art. Furthermore, the modules may be embodied in any non-transitory computer readable medium for use by or in connection with an instruction execution system, apparatus, or device, such as a computer-based system, processor-containing system, or other system that can fetch the instructions from the instruction execution system, apparatus, or device and execute the instructions.

One or more of the controller and processor can be comprised partially or completely of any suitable structure or arrangement, e.g., one or more integrated circuits. Also, it should be understood that the computing device shown include other components, hardware and software (not shown) that are used for the operation of other features and functions of the computing devices not specifically described herein.

The functions described herein may be implemented in hardware, software, firmware, or any combination thereof. If implemented in software, the functions may be stored on or transmitted as one or more instructions or code on a non-transitory computer-readable medium. The methods illustrated in the figures may be implemented in a general, multi-purpose or single purpose processor. Such a processor will execute instructions, either at the assembly, compiled or machine-level, to perform that process. Those instructions can be written by one of ordinary skill in the art following the description of the figures and stored or transmitted on a non-transitory computer readable medium. The instructions may also be created using source code or any other known computer-aided design tool. A non-transitory computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents.

1. A method for security screening a screening subject, comprising:
measuring by at least one biometric sensor at least one biometric parameter of the screening subject;
scoring by a biometric analysis engine coupled to the biometric sensor the at least one biometric parameter measured of the screening subject; and
generating by the biometric analysis engine biometric parameter feedback in such a way that a security screening agent either terminates or escalates the security screening of the screening subject based on the generated biometric parameter feedback.

2. The method as recited in claim 1, wherein the at least one biometric parameter includes at least one of a heart/pulse rate, an eye movement, a facial temperature and a voice pitch variation of the screening subject.

3. The method as recited in claim 1, wherein measuring the at least one biometric parameter of the screening subject includes measuring the rate of change of at least one biometric parameter of the screening subject over a plurality of points in time.

4. The method as recited in claim 1, wherein scoring the at least one biometric parameter includes scoring the at least one biometric parameter using a graphical representation scoring scheme.

5. The method as recited in claim 1, wherein scoring the at least one biometric parameter includes scoring the at least one biometric parameter using an exceptions counting scoring scheme.

6. The method as recited in claim 1, wherein scoring the at least one biometric parameter includes scoring the at least one biometric parameter using a numerical value scoring scheme.

7. The method as recited in claim 1, wherein at least one of the biometric sensors is a passive sensor that does not makes physical contact with the screening subject when measuring the at least one biometric parameter of the screening subject.

8. The method as recited in claim 1, wherein measuring the at least one biometric parameter of the screening subject includes measuring the at least one biometric parameter of the screening subject in response to a stimulus to the screening subject.

9. The method as recited in claim 1, wherein generating biometric parameter feedback includes providing by at least one of visual and aural feedback.

10. A system for security screening a screening subject, comprising:
at least one biometric sensor that measures at least one biometric parameter of the screening subject;
a biometric analysis engine coupled to the biometric sensor for scoring the biometric parameter of the screening subject measured by the biometric sensor,
wherein the biometric analysis engine generates biometric parameter feedback in such a way that a security screening agent either terminates or escalates the security screening of the screening subject based on the generated biometric parameter feedback.

11. The system as recited in claim 10, wherein the at least one biometric sensor measures at least one of a heart/pulse rate, an eye movement, a facial temperature and a voice pitch variation of the screening subject.

12. The system as recited in claim 10, wherein the at least one biometric sensor measures the rate of change of at least one biometric parameter of the screening subject over a plurality of points in time.

13. The system as recited in claim 10, wherein the biometric analysis engine scores the at least one biometric parameter using a graphical representation scoring scheme.

14. The system as recited in claim 10, wherein the biometric analysis engine scores the at least one biometric parameter using at least one of an exceptions counting scoring scheme and a numerical value scoring scheme.

15. The system as recited in claim 10, wherein at least one of the biometric sensors is a passive sensor that does not makes physical contact with the screening subject when measuring the at least one biometric parameter of the screening subject.

16. The system as recited in claim 10, wherein the at least one biometric sensor measures the at least one biometric parameter of the screening subject in response to a stimulus to the screening subject.

17. The system as recited in claim 10, further comprising at least one of a visual and aural feedback component coupled to the engine for displaying biometric parameter feedback.

18. A non-transitory computer readable medium having instructions stored thereon which, when executed by a processor, carry out a method for security screening a screening subject, the instructions comprising:
instructions to measure at least one biometric parameter of the screening subject;
instructions to score the at least one biometric parameter measured of the screening subject; and
instructions to generate biometric parameter feedback in such a way that a security screening agent either terminates or escalates the security screening of the screening subject based on the generated biometric parameter feedback.

19. The non-transitory computer readable medium as recited in claim 18, wherein instructions to measure at least one biometric parameter of the screening subject include instructions to measure at least one a heart/pulse rate, an eye movement, a facial temperature and a voice pitch variation of the screening subject.

20. The non-transitory computer readable medium as recited in claim 18, wherein instructions to score the at least one biometric parameter measured of the screening subject include instructions to score the at least one biometric parameter measured of the screening subject to measure using at least one of a graphical representation scoring scheme, an exceptions counting scoring scheme and a numerical value scoring scheme.
